(19) United States
(12) Patent Application Publication
(10) Pub. No.: US 2025/0067113 A1
(43) Pub. Date: Feb. 27, 2025

(54) ASTRAGAL LATCHING AND PANEL FEATURES

(71) Applicant: THERMA-TRU CORP., Maumee, OH (US)

(72) Inventors: Alexander Wilson, Toledo, OH (US); Shawn Clark, Poplar Bluff, MO (US)

(21) Appl. No.: 18/812,137

(22) Filed: Aug. 22, 2024

Related U.S. Application Data
(60) Provisional application No. 63/578,223, filed on Aug. 23, 2023.

(51) Int. Cl. E06B 3/36; E05C 7/04; E06B 7/16

(52) U.S. Cl. CPC E06B 3/365; E05C 7/04; E06B 7/16

(57) ABSTRACT

An astragal housing includes a housing frame and an interior cover. The housing frame includes a vertically extending mounting wall defining a mounting surface configured for external attachment along a non-hinged vertical edge of a passive door panel, inner and outer vertically extending latch channel walls extending from the mounting wall in a first direction to define a vertically extending latch channel opposite the mounting surface, and inner and outer vertically extending door channel walls extending from the mounting wall in a second direction opposite the first direction to define a vertically extending door channel including the mounting surface. The interior cover has a first hook portion extending over a distal edge of the inner latch channel wall and a second hook portion extending over a distal edge of the inner door channel wall, the interior cover defining an inner lateral surface of the astragal housing.

### CROSS-REFERENCE TO RELATED APPLICATION

This application claims priority to and all benefit of U.S. Provisional Patent Application Ser. No. 63/578,223, filed on Aug. 23, 2023, for ASTRAGAL LATCHING AND PANEL FEATURES, the entire disclosure of which is incorporated herein by reference.

### BACKGROUND

Double entrance doorways are used in a large variety of residential homes and commercial buildings. In a conventional double door entryway 10, as shown in FIG. 1, an active door 11 provides for day to day ingress and egress to and from the residential home or building, and an inactive or passive door 12 remains closed, except in instances when a width greater than or equal to the width of the active door and less than or equal to the width of the double entrance doorway is required, such as, for example, for delivery of furniture and/or equipment that cannot fit through the double entrance doorway. If large objects, such as furniture and/or equipment must pass through the double entrance doorway, both the normally inactive door and the active door of the doorway are opened, to create a wide entrance way, through which the furniture and/or equipment may pass.

Mating edges of the passive door 12 and the active door 11 do not contact one another directly, but are separated by an astragal 15, the astragal being attached to the non-hinged vertical edge of the passive door. The astragal 15 extends the length of the passive door 12, cushioning the closing of the active door 11 and providing latching points (strike plates 19a, 19b) for a deadbolt 11a and/or door latch 11b of the active door, and sealing gaps between the passive door and the active door.

The astragal 15 may include upper and/or lower bolt-slide or shoot bolt assemblies 16, 17, which lock the astragal and the passive door 12 to upper and lower portions 13a, 13b of a door frame 13 surrounding the double entrance doorway. The shoot bolt 16, 17 assemblies have bolts, which slide within upper and lower ends of the astragal and are extendable vertically outward to extend beyond the ends of the astragal, and are received by upper and lower apertures in the upper and lower portions 13a, 13b of the door frame 13, also known as the header and threshold sill, respectively, to lock the astragal 15 and passive door 12 in place. The astragal 15 may be provided with an actuator operable to retract the shoot bolts to permit opening of the passive door.

### SUMMARY OF THE DISCLOSURE

In an exemplary embodiment of the present disclosure, an astragal housing includes a housing frame and an interior cover. The housing frame includes a vertically extending mounting wall defining a mounting surface configured for external attachment along a non-hinged vertical edge of a passive door panel, inner and outer vertically extending latch channel walls extending from the mounting wall in a first direction to define a vertically extending latch channel opposite the mounting surface, and inner and outer vertically extending door channel walls extending from the mounting wall in a second direction opposite the first direction to define a vertically extending door channel including the mounting surface. The interior cover includes a first hook portion extending over a distal edge of the inner latch channel wall and a second hook portion extending over a distal edge of the inner door channel wall, the interior cover defining an inner lateral surface of the astragal housing.

In another exemplary embodiment of the present disclosure, an astragal housing includes a housing frame and an exterior cover. The housing frame includes a vertically extending mounting wall defining a mounting surface configured for external attachment along a non-hinged vertical edge of a passive door panel, an inner lateral wall portion extending from an inner lateral end of the mounting wall, and an outer lateral wall portion extending from an outer lateral end of the mounting wall. The inner lateral wall portion defines an inner latch channel wall extending from the mounting wall in a first direction and an inner door channel wall extending from the mounting wall in a second direction opposite the first direction. The outer lateral wall portion defines an outer latch channel wall extending from the mounting wall in a first direction and an outer door channel wall extending from the mounting wall in a second direction opposite the first direction. The exterior cover includes a first hook portion extending over a first end of the outer lateral wall portion and a second hook portion extending over a second end of the outer lateral wall portion, the exterior cover defining an outer lateral surface of the astragal housing.

In another exemplary embodiment of the present disclosure, an astragal includes an elongated housing, a shoot bolt, and an actuator. The elongated housing includes a first end and a second end, a vertically extending mounting surface configured for external attachment along a non-hinged vertical edge of a passive door panel, and a vertically extending channel opposite the mounting surface. The shoot bolt is slidably disposed in the housing channel proximate to the first end of the housing and is movable between a retracted position and an extended position. The actuator is disposed in the housing channel and is operably coupled to the shoot bolt. The actuator includes a lever rotatable about a horizontal axis extending perpendicular to the mounting surface for movement of the shoot bolt between the retracted position and the extended position.

In another exemplary embodiment of the present disclosure, an astragal includes an elongated housing, a shoot bolt, and an actuator. The elongated housing includes a first end and a second end, a vertically extending mounting surface configured for external attachment along a non-hinged vertical edge of a passive door panel, and a vertically extending channel opposite the mounting surface. The shoot bolt is slidably disposed in the housing channel proximate to the first end of the housing and is movable between a retracted position and an extended position. The actuator is disposed in the housing channel and is operably coupled to the shoot bolt. The actuator including a lever movable between a fixed position preventing pivoting movement of the lever and a rotatable position permitting pivoting movement of the lever for movement of the shoot bolt between the retracted position and the extended position.

In another exemplary embodiment of the present disclosure, an astragal includes an elongated housing, first and second shoot bolts, and an actuator. The elongated housing includes a first end and a second end, a vertically extending mounting surface configured for external attachment along a non-hinged vertical edge of a passive door panel, and a vertically extending channel opposite the mounting surface. The first shoot bolt is slidably disposed in the housing channel proximate to the first end of the housing, the first shoot bolt being movable between a retracted position and an extended position. The second shoot bolt is slidably disposed in the housing channel proximate to the second end of the housing, the second shoot bolt being movable between a retracted position and an extended position. The actuator is disposed in the housing channel and is operably coupled to the first shoot bolt by a first linkage and operably coupled to the second shoot bolt by a second linkage. The actuator includes a lever rotatable to a first position for linked movement of the first and second shoot bolts to the retracted position, and rotatable to a second position for linked movement of the first and second shoot bolts from the retracted position to the extended position.

In another exemplary embodiment of the present disclosure, an astragal includes an elongated housing, a shoot bolt, an actuator, and a spring biasing arrangement. The elongated housing includes a first end and a second end, a vertically extending mounting surface configured for external attachment along a non-hinged vertical edge of a passive door panel, and a vertically extending channel opposite the mounting surface. The shoot bolt is slidably disposed in the housing channel proximate to the first end of the housing and is movable between a retracted position and an extended position. The actuator is disposed in the housing channel and is operably coupled to the shoot bolt. The actuator includes a lever rotatable to a first position for movement of the shoot bolt to the retracted position, and rotatable to a second position for movement of the shoot bolt to the extended position. The spring biasing arrangement is configured to bias the lever from each of the first and second positions towards an intermediary position between the first and second positions.

### BRIEF DESCRIPTION OF THE DRAWINGS

Further features and advantages of the invention will become apparent from the following detailed description made with reference to the accompanying drawings, wherein:

FIG. 1 is a perspective view of a conventional double door arrangement;

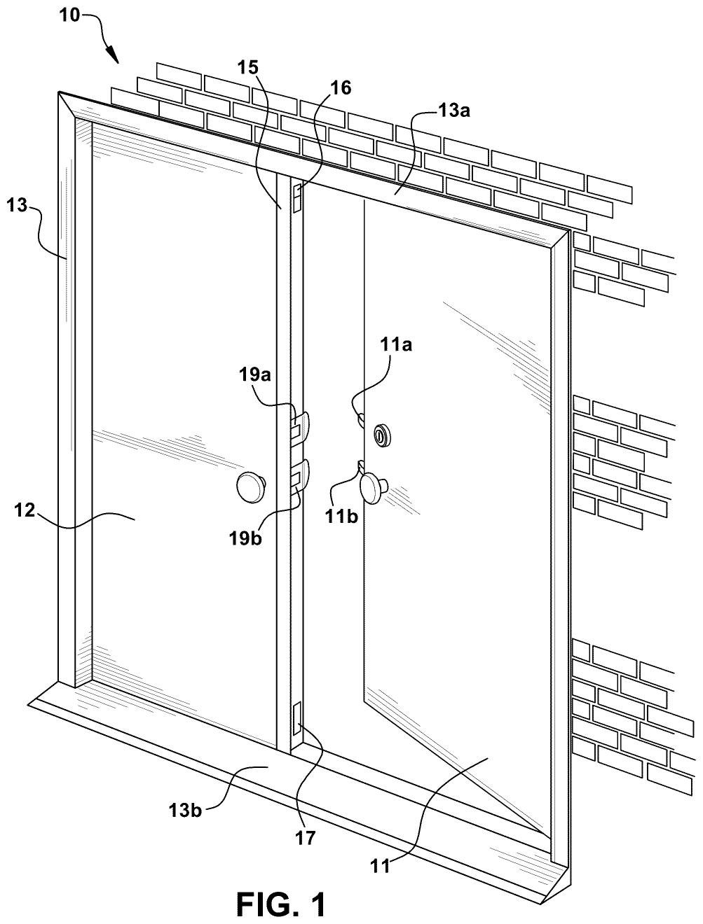

FIG. 2 is a perspective view of an astragal assembly according to an exemplary embodiment of the present disclosure;

FIG. 2A is an enlarged side elevational view of an upper end portion of the astragal assembly of FIG. 2, taken from the section marked 2A;

FIG. 2B is an enlarged partial perspective view of a lower end portion of the astragal assembly of FIG. 2, taken from the section marked 2B;

FIG. 2C is an enlarged partial perspective view of an actuator portion of the astragal assembly of FIG. 2, taken from the section marked 2C;

FIG. 3 is a perspective view of the actuator of the astragal assembly of FIG. 2, with portions of the actuator shown in phantom to illustrate additional features of the actuator;

FIG. 3A is a perspective view of the linkage arrangement of the astragal assembly of FIG. 2;

FIG. 4 is a perspective view of the upper shoot bolt arrangement of the astragal assembly of FIG. 2;

FIG. 5 is a perspective view of the lower shoot bolt arrangement of the astragal assembly of FIG. 2;

FIG. 6A is a cross-sectional upper end view of the astragal assembly of FIG. 2, taken along the line 6A-6A;

FIG. 6B is a cross-sectional lower end view of the astragal assembly of FIG. 2, taken along the line 6B-6B;

FIG. 7 is a perspective upper end view of the upper trim cap portion of the astragal assembly of FIG. 2;

FIG. 7A is a lower perspective view of the upper trim cap of the astragal assembly of FIG. 2;

FIG. 8 is a perspective lower end view of the lower trim cap portion of the astragal assembly of FIG. 2; and

FIG. 8A is an upper perspective view of the lower trim cap of the astragal assembly of FIG. 2.

### DETAILED DESCRIPTION

This Detailed Description merely describes exemplary embodiments and is not intended to limit the scope of the claims in any way. Indeed, the invention as claimed is broader than and unlimited by the described embodiments, and the terms used have their full ordinary meaning.

According to an exemplary aspect of the present disclosure, an astragal may be provided with a latching arrangement having an actuator including a lever rotatable about a horizontal axis extending perpendicular to the mounting surface between a first position for movement of a shoot bolt to a retracted position and a second position for movement of the shoot bolt to an extended position.

According to another exemplary aspect of the present disclosure, a latching arrangement of an astragal may additionally or alternatively include a lever that is movable between a fixed position preventing pivoting movement of the lever and a rotatable position permitting pivoting movement of the lever for movement of a shoot bolt between a retracted position and an extended position.

According to still another exemplary aspect of the present disclosure, a latching arrangement of an astragal may additionally or alternatively include a lever that is rotatable to a first position for movement of the shoot bolt to the retracted position, and rotatable to a second position for movement of the shoot bolt to the extended position, and a biasing mechanism configured to bias the lever from each of the first and second positions towards an intermediary position between the first and second positions.

According to yet another exemplary aspect of the present disclosure, a latching arrangement of an astragal may additionally or alternatively include first and second shoot bolts movable between a retracted position and an extended position, and an actuator operably coupled to the first shoot bolt by a first linkage and operably coupled to the second shoot bolt by a second linkage. The exemplary actuator includes a lever rotatable to a first position for linked movement of the first and second shoot bolts to the retracted position, and rotatable to a second position for linked movement of the first and second shoot bolts to the extended position.

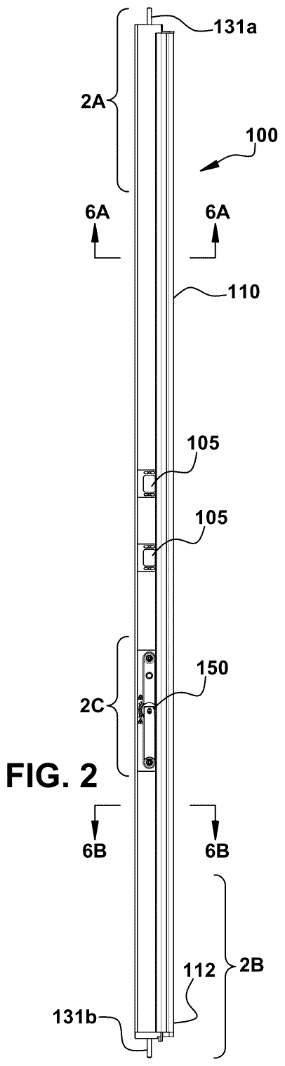

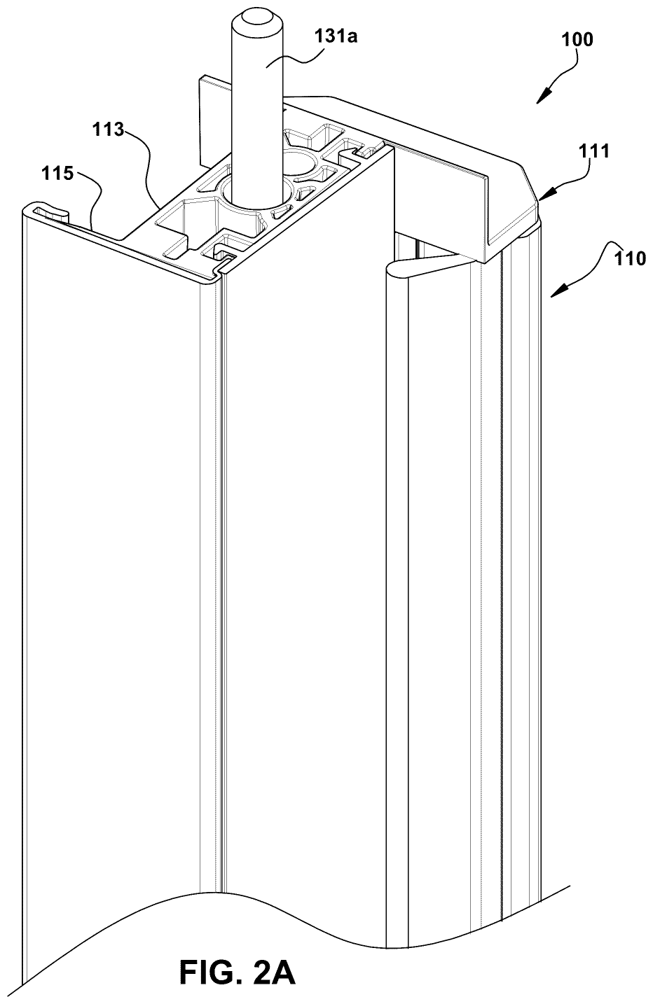

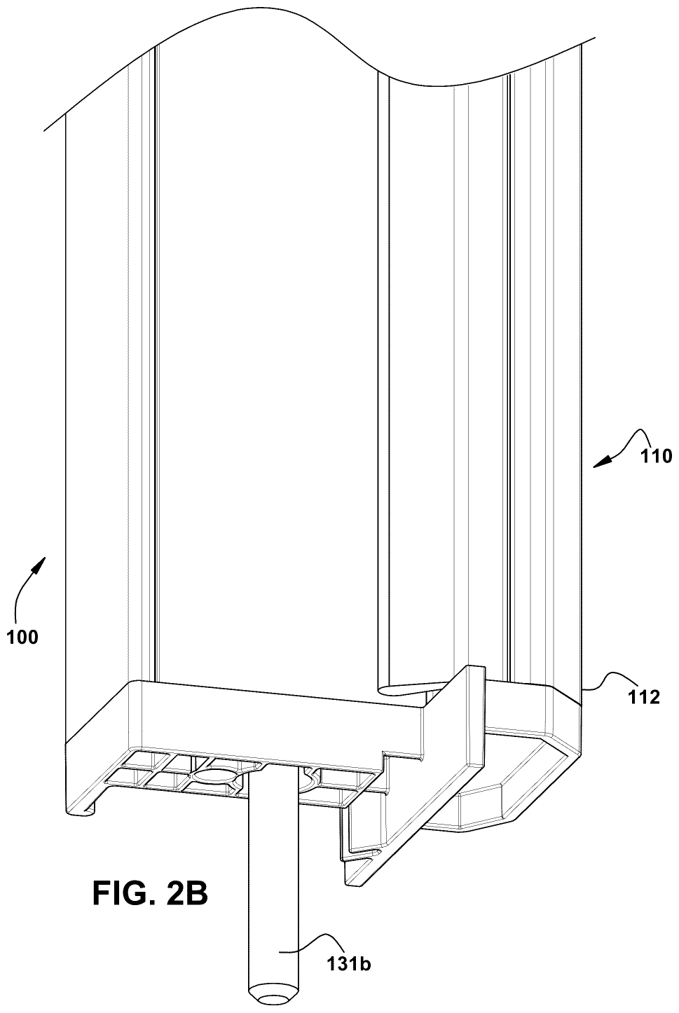

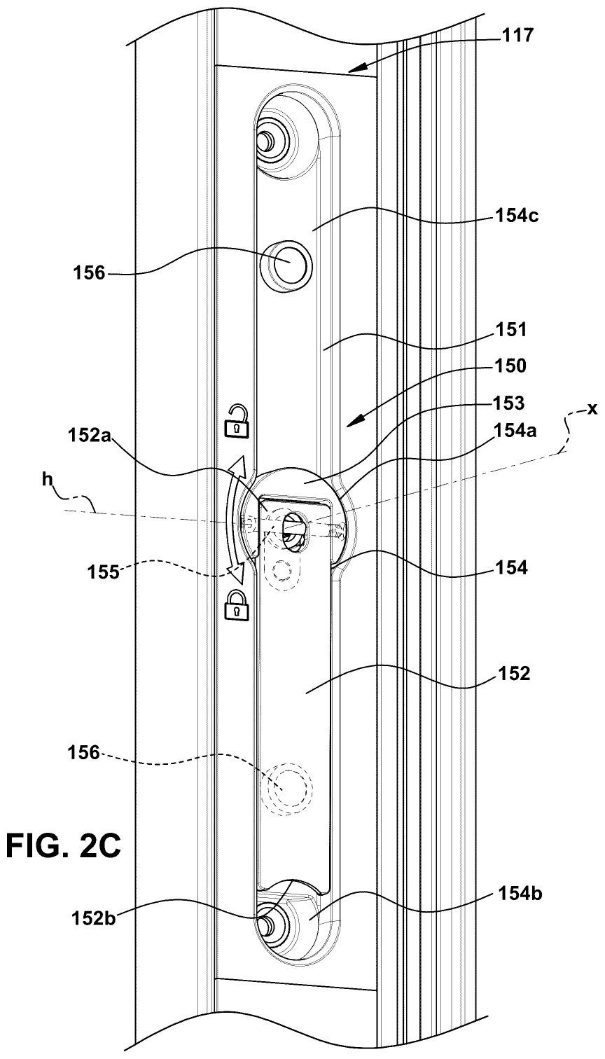

FIGS. 2 and 2A-2C illustrate an exemplary astragal assembly 100 including an elongated housing 110 having a first, upper end 111 and a second, lower end 112, an upper shoot bolt 131a extendable from the upper end of the astragal housing (FIG. 2A), and a lower shoot bolt 131b extending from the lower end of the astragal housing (FIG. 2B). A rear, mounting side of the astragal housing 110 includes a mounting surface 113 disposed between door channel walls 114, 115 defining a door channel 116 (FIG. 2A) for receiving and mounting to a non-hinged vertical edge of a passive door (not shown). The astragal assembly 100 further includes an actuator 150 (FIG. 2C) retained in a latch channel 117 in the astragal housing 110, and accessible on an inner, doorway facing surface of the astragal housing. As described in greater detail below, the actuator 150 is operably coupled to the upper and lower shoot bolts 131a, 131b for movement of the shoot bolts between an extended position (e.g., engaging upper and lower anchoring holes in the door frame, not shown) and a retracted position (e.g., withdrawn from upper and lower anchoring holes in the door frame), for releasably securing the astragal assembly 100 and attached passive door (not shown) in a closed position within the door frame. As shown, the latch channel 117 may carry one or more strike plates 105 for engagement with latches and/or deadbolts of the active door.

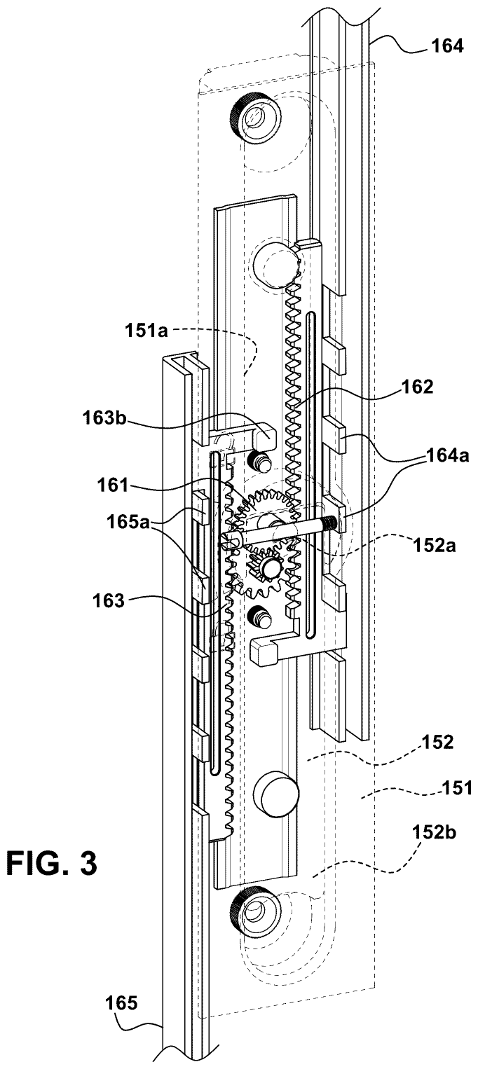

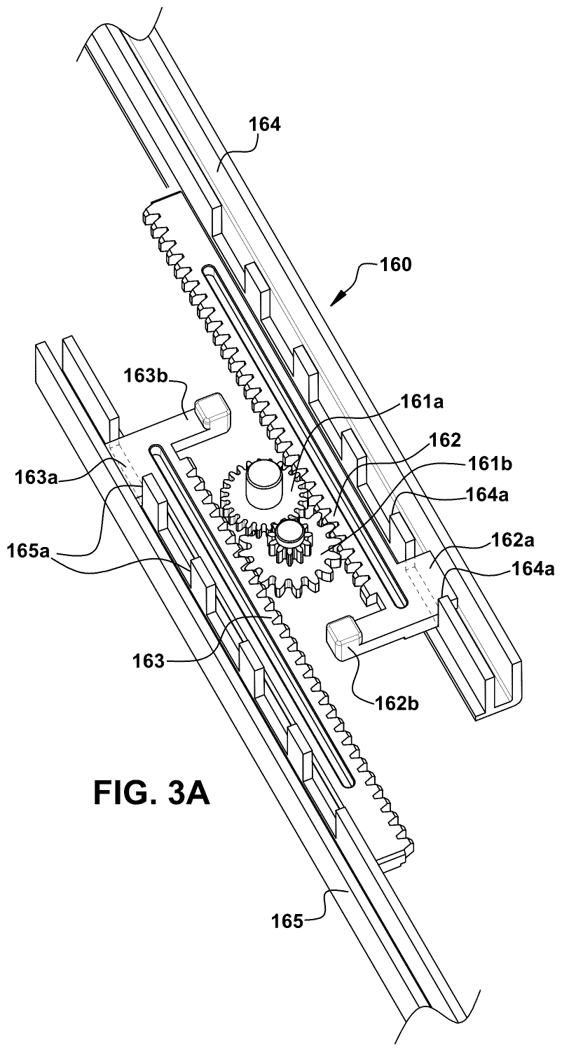

Referring to FIGS. 2C and 3, the exemplary actuator 150 includes an actuator base or base member 151 installed in the latch channel 117 of the astragal housing 110, and a lever 152 rotatably attached within a lever recess portion 154 of the actuator base 151. While many types of rotatable attachment may be utilized, in the illustrated example, the proximal end 152a of the lever 152 is secured to a rotatable hub 153 disposed in a central recessed portion 154a of the actuator base 151, to provide for rotation of the hub and lever about a horizontal axis x extending perpendicular to the mounting surface 113.

As shown, the lever 152 may be receivable in a first end recessed portion 154b of the actuator base 151 when the lever is in a first (e.g., downward, as shown) position, for example, a position corresponding with an extended position of the upper and lower shoot bolts 131a, 131b. The retention of the lever 152 in this first end recessed portion 154b provides a fixed position of the lever, blocking movement of the lever out of this first position. To rotate the lever 152 out of the first position, the lever may be movable out of the recessed portion 154b of the actuator base 151, to a rotatable position. In the illustrated example, the lever 152 is attached to the hub 153 by a pivot pin 155, such that the lever may be pivoted, about a hinge axis h, defined by the pivot pin, out of the recessed portion 154b, for example, by grasping a distal end 152b (which may be contoured to facilitate user engagement) of the lever 152 and pulling the distal end of the lever outward. In this rotatable position, the portion of the lever 152 extending beyond the hub 153 is clear of the recessed portion 154b, thereby permitting rotation of the lever about the horizontal axis x.

In the rotatable orientation, the lever 152 may be rotated to a second (e.g., upward) position, for example, a position corresponding with a retracted position of the upper and lower shoot bolts 131a, 131b. When rotated to this second position, the lever 152 may be received in a second end recessed portion 154c of the actuator base 151, by pivoting the lever about the hinge axis h (defined by pivot pin 155) into the recessed portion. In some exemplary embodiments, the recessed portions 154b, 154c may include magnetic nubs or discs 156 that interlock with a rear socket (not shown) in the lever 152 to securely retain the lever in the corresponding recessed portion until it is intentionally pivoted outward by the user.

Many different types of linkages may be used to drive actuation of the shoot bolts 131a, 131b by operation of the lever 152. In the illustrated exemplary linkage 160, as shown in FIGS. 3 and 3A, the hub 153 is rotationally fixed to a spur gear 161a that is linked to first and second rack gears 162, 163 (e.g., directly or by second spur gear 161b, as shown), to slidably move the rack gears along side portions of the actuator base 151 upon rotation of the lever 152 and hub 153. Outer lateral leg portions 162a, 163a of the rack gears 162, 163 interlock with proximal notched portions 164a, 165a of first and second slide members 164, 165, for slidable movement therewith. The first slide member 164 extends toward the first, upper end of the astragal 100 for linked attachment to the upper shoot bolt 131a, and the second slide member 165 extends toward the second, lower end of the astragal for linked attachment to the lower shoot bolt 131b, as described in greater detail below.

As shown, the rack gears 162, 163 may additionally include inner lateral leg portions 162b, 163b which may extend into slotted portions 151a of the actuator base 151 for guided vertical movement of the rack gears during actuation.

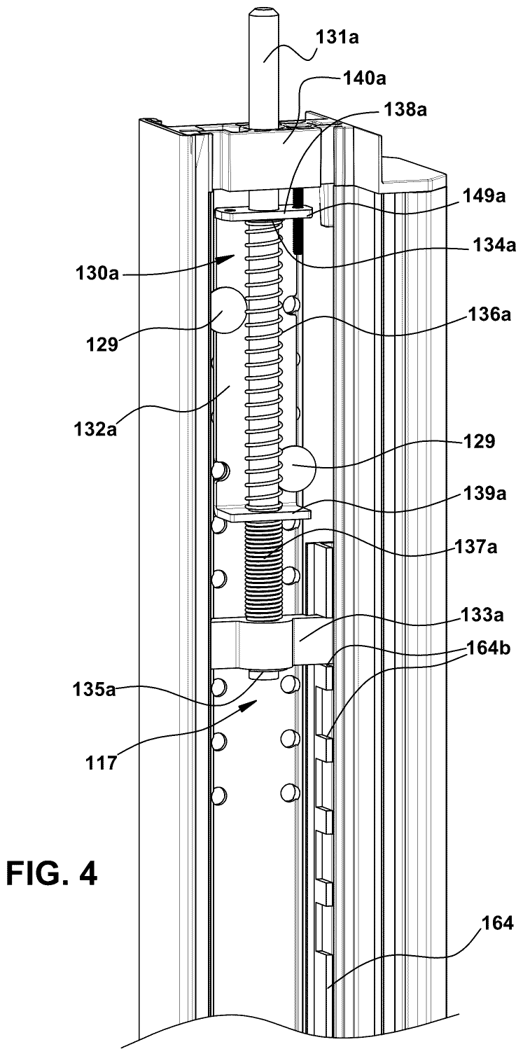

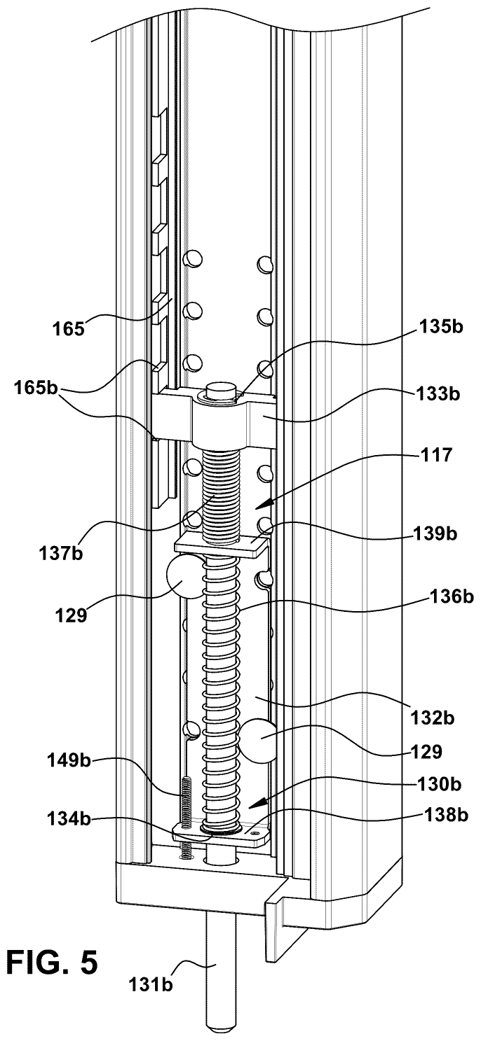

Many different types of shoot bolt arrangements may be used for linked connection to actuator driven slide members in an astragal. In the illustrated example, as shown in FIGS. 4 and 5, the upper and lower shoot bolts 131a, 131b are carried by brackets 132a, 132b mounted in the latch channel 117 (e.g., by fasteners 129, which may further mount to the passive door edge), with the shoot bolts slidable through outer and inner apertured flanges or barrier elements 138a, 138b, 139a, 139b of the brackets. In other embodiments (not shown), the flanges or barrier elements may be integrally formed with the actuator housing, eliminating the inclusion of a bracket.

The shoot bolt assemblies 130a, 130b further include slide blocks 133a, 133b, assembled with the shoot bolts 131a, 131b and extending laterally to interlock with distal notched portions 164b, 165b of the corresponding slide members 164, 165, such that sliding movement of the slide members (as driven by the lever 152 and linkage arrangement 160 described above) drives movement of the slide blocks. The fully extended position of each shoot bolt 131a, 131b may be limited by an outer stop portion 134a, 134b (e.g., a retaining ring or spring washer secured in a notched portion of the shoot bolt) that abuts the outer flange 138a, 138b in the extended position. The fully retracted position of each shoot bolt 131a, 131b may be limited by an inner stop portion 135a, 135b (e.g., a retaining ring or spring washer secured in a notched portion of the shoot bolt), at the inner end of the shoot bolt, which abuts an inner surface of the slide block 133a, 133b. As shown, the slide members 164, 165 may include multiple proximal and distal notch portions 164a, 165a, 164b, 165b to adjust the positions of the slide members with respect to the rack gears 162, 163 and slide blocks 133a, 133b, for example, to adjust the degree to which the shoot bolts 131a, 131b extend from the astragal housing 110 in the extended or locking position.

While the slide blocks may be directly affixed to the shoot bolts for lever driven actuation of the shoot bolts, in some embodiments, the slide blocks may be connected with the shoot bolts by a biasing mechanism configured to provide for some relative movement of each slide block with respect to the corresponding shoot bolt. This basing mechanism may, for example, allow for full actuation of the lever even in cases that the shoot bolt stop short of its full extended position (e.g., due to shallower door frame anchor holes). Additionally or alternatively, the biasing mechanism may provide for initial spring biased movement of the lever when the lever is moved from the fixed position to the rotatable position, for example, to provide an intuitive indication of the direction for rotating the lever from one of the first and second positions to the other of the first and second positions.

As shown, each shoot bolt assembly 130a, 130b may include a spring biasing subassembly including an outward biasing spring 136a, 136b installed over the shoot bolt 131a, 131b between the inner bracket flange 139a, 139b and the outer stop portion 134a, 134b to apply an outward biasing force to the shoot bolt. Each shoot bolt assembly 130a, 130b may additionally or alternatively include an inward biasing spring 137a, 137b installed over the shoot bolt 131a, 131b between the inner bracket flange 139a, 139b and the slide block 133a, 133b. In some such embodiments, the outward and inward biasing springs 136a, 136b, 137a, 137b may have substantially matching lengths and spring rates, for example, for counterbalanced biasing (e.g., against the inner bracket flange or barrier member) of the shoot bolts 131a, 131b, and the linked lever 152, toward an intermediary position between the first and second end positions, which may, but need not, be about halfway between the first and second positions.

In such an arrangement, when the lever 152 is held in the first position (e.g., by retention in the first recessed portion 154b of the actuator base 151), each inward biasing spring 137a, 137b is compressed between the inner bracket flange 139a, 139b and the extended slide block 133a, 133b, and each outward biasing spring 136a, 136b is extended, such that the inward biasing spring exerts a greater biasing force than the outward biasing spring. When the lever 152 is moved from the fixed position to the rotatable position, the inward biasing spring 137a, 137b exerts an inward biasing force against the slide block 133a, 133b, rotating the linked lever 152 toward the second position, to provide an indication to the user of the direction of rotation needed to retract the shoot bolts 131a, 131b.

When the lever 152 is held in the second position (e.g., by retention in the first recessed portion 154b of the actuator base 151), each outward biasing spring 136a, 136b is compressed between the inner bracket flange 139a, 139b and the outer stop portion 134a, 134b, and each inward biasing spring 137a, 137b is extended, such that the outward biasing spring exerts a greater biasing force than the inward biasing spring. When the lever 152 is moved from the fixed position to the rotatable position, the outward biasing spring 136a, 136b exerts an outward biasing force against the outer stop portion 134a, 134b, rotating the linked lever 152 toward the first position, to provide an indication to the user of the direction of rotation needed to retract the shoot bolts 131a, 131b.

According to an exemplary aspect of the present disclosure, an astragal may be provided with an astragal housing carrying one or more external panels or covers providing an easily adaptable and customizable exterior surface aesthetic for the astragal. For example, an astragal housing may be selectively fitted with one or more of an exterior cover (covering an exterior portion of the astragal housing), an interior cover (covering an interior portion of the astragal housing) and a channel cover (covering the latch channel in the astragal housing, opposite the passive door mounting surface of the astragal housing).

According to another exemplary aspect of the present disclosure, an astragal may include a housing having inner and outer vertically extending latch channel walls extending from a mounting wall in a first direction, inner and outer vertically extending door channel walls extending from the mounting wall in a second direction opposite the first direction, and an interior cover having a first hook portion extending over a distal edge of the inner latch channel wall and a second hook portion extending over a distal edge of the inner door channel wall, such that the interior cover defines an inner lateral surface of the astragal housing.

According to another exemplary aspect of the present disclosure, an astragal may additionally or alternatively include a housing having an outer lateral wall portion extending from an outer lateral end of the mounting wall and defining the outer latch channel wall and the outer door channel wall, and an exterior cover having a first hook portion extending over a first end of the outer lateral wall portion and a second hook portion extending over a second end of the outer lateral wall portion, the exterior cover defining an outer lateral surface of the astragal housing.

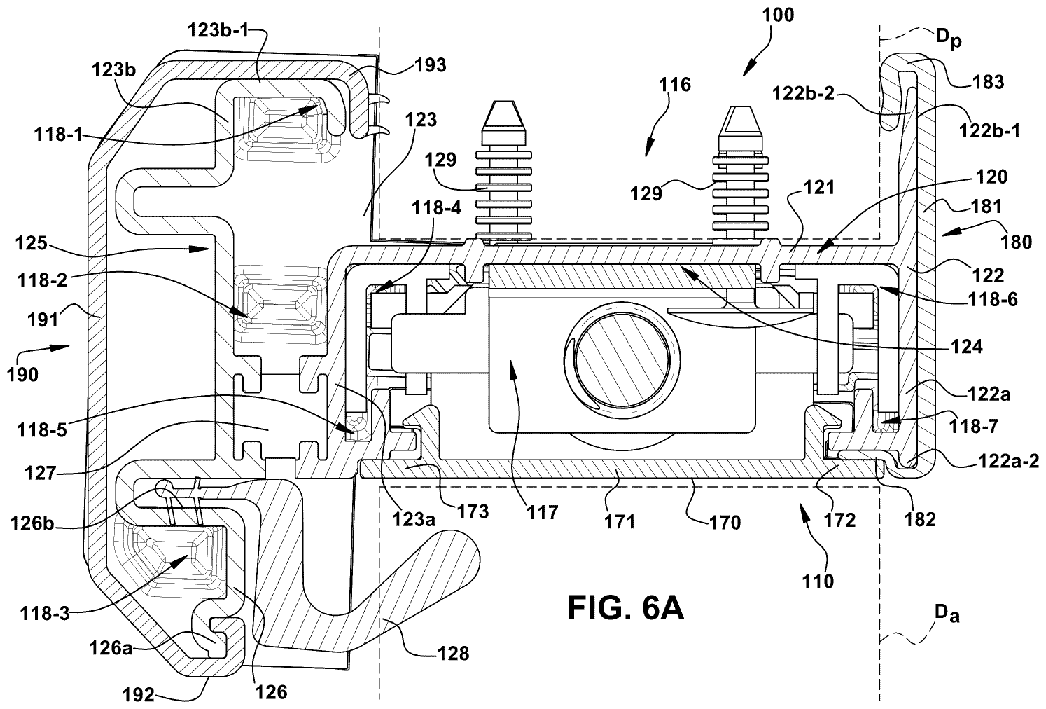

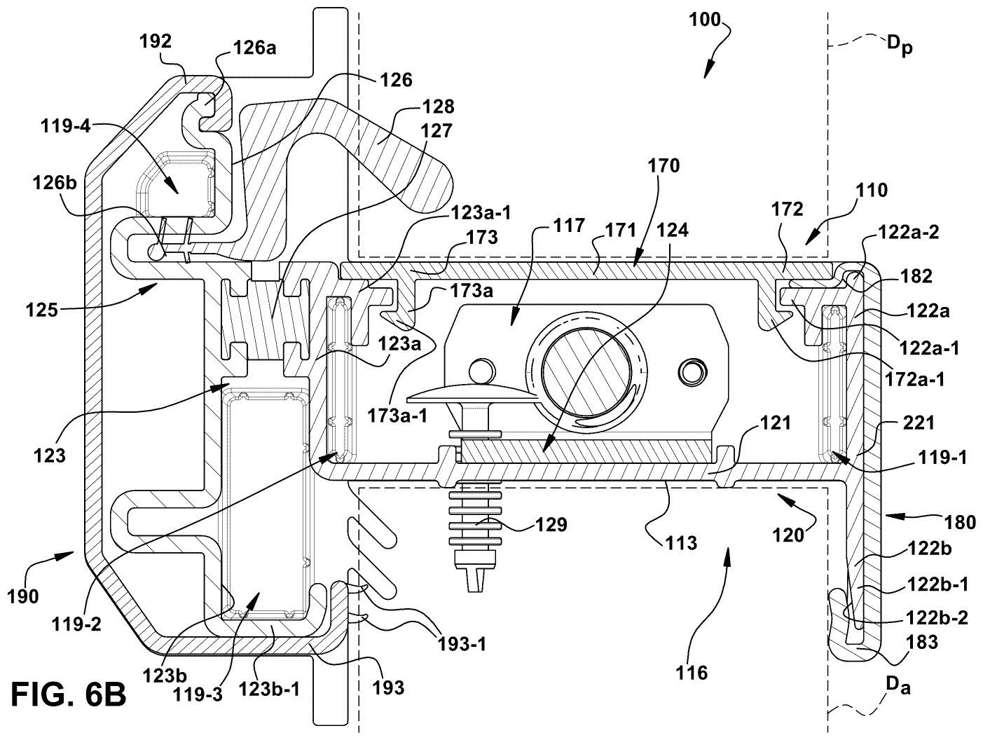

Referring to the cross-sectional views of FIGS. 6A and 6B, the exemplary astragal 100 includes a housing 110 formed from a rigid (e.g., aluminum) housing frame 120. The housing frame 120 includes a vertically extending mounting wall 121 defining the mounting surface 113, an inner lateral wall portion 122 extending from an inner lateral end of the mounting wall, and an outer lateral wall portion 123 extending from an outer lateral end of the mounting wall. The inner lateral wall portion 122 defines an inner latch channel wall 122a extending from the mounting wall 121 in a first direction and an inner door channel wall 122b extending from the mounting wall in a second direction opposite the first direction. The outer lateral wall portion 123 defines an outer latch channel wall 123a extending from the mounting wall 121 in the first direction and an outer door channel wall 123b extending from the mounting wall in the second direction. The inner and outer latch channel walls 122a, 123a define the latch channel 117, in which the actuator 150 and shoot bolt assemblies 130, 140 are retained. The inner and outer door channel walls 122b, 123b, together with the mounting wall 121, define the door channel 116 for receiving and mounting to a non-hinged vertical edge of a passive door Dₚ.

While the housing frame may be a monolithic component, in some embodiments, the housing frame may be formed from inner and outer frame members attached by a thermal barrier element, for example, to limit thermal conductivity between the interior and exterior portions of the housing frame. In the illustrated embodiment, the housing frame 120 includes an inner frame member 124 defining the inner lateral wall portion 122 and the outer latch channel wall 123a, and an outer frame member 125 defining the outer door channel wall 123b and an active door engaging shoulder portion 126 laterally outward of and extending forward of the outer latch channel wall 122b for engagement with a non-hinged vertical edge of an active door panel Da when the active door panel is in the closed position. The inner and outer frame members 124, 125 are joined by an elongated thermal barrier element 127 provided in a material (e.g., high density urethane or other suitable thermally insulating material) selected to limit thermal conductivity between the interior and exterior portions of the housing frame 120.

To provide a finished, aesthetically desirable active door facing end surface of the astragal, one or more channel covers may be provided to cover portions of the latch channel, for example, portions of the latch channel extending beyond the actuator and strike plates. In the illustrated embodiment, the astragal 100 includes channel covers 170 having inner and outer lateral end portions 172, 173 that engage the inner and outer latch channel walls 122a, 123a such that a panel portion 171 of the channel cover 170 covers at least a portion of the latch channel 117. While may different attachment arrangements may be used, in the illustrated embodiment, the lateral end portions 172, 173 of the channel cover 170 include flexible tab portions 172a, 173a that snap into retaining engagement with laterally inward extending flange portions 122a-1, 123a-1 of the inner and outer latch channel walls 122a, 123a. The flexible tab portions 172a, 173a may include tapered distal detent portions 172a-1, 173a-1 to facilitate snap-fit retention with the flange portions 122a-1, 123a-1.

To provide a finished, aesthetically desirable interior surface of the astragal, an interior cover may be installed over the inner lateral wall portion of the housing frame. In the illustrated embodiment, the astragal 100 includes an interior cover 180 having a first hook portion 182 extending over a distal edge 122a-2 of the inner latch channel wall 122a, and a second hook portion 183 extending over a distal edge 122b-1 of the inner door channel wall 122b, such that a panel portion 181 of the interior cover 180 covers the inner lateral wall portion 122 of the housing frame 120 to define an inner lateral surface of the astragal housing 110.

In some embodiments, the first hook portion 182 of the interior cover 180 may be captured between the inner lateral end portion 172 of the channel cover 170 and the inner latch channel wall flange portion 122a-1, with the first hook portion being contoured to provide a mating surface for the inner lateral end portion of the channel cover.

In some embodiments, the second hook portion 183 of the interior cover 180 may be laterally compressively biased (e.g., like a bobby pin type hook portion) against the inner door channel wall 122b, for example, to pull the first hook portion 182 inward against the inward extending flange portion 122a-1 and distal edge 122a-2 of the inner latch channel wall 122a. To facilitate this pulling engagement, the distal edge 122b-1 of the inner door channel wall 122b may include a tapered wall surface 122b-2 against which the second hook portion 183 compresses.

To provide a finished, aesthetically desirable exterior surface of the astragal, an exterior cover may be installed over the outer lateral wall portion of the housing frame. In the illustrated embodiment, the astragal 100 includes an exterior cover 190 having a first hook portion 192 extending over a distal end 126a of the outer lateral wall shoulder portion 126, and a second hook portion 193 extending over a distal end 123b-1 of the outer door channel wall 123b, such that a panel portion 191 of the exterior cover 190 covers the outer lateral wall portion 123 of the housing frame 120 to define an outer lateral surface of the astragal housing 110.

As shown, the second hook portions 183, 193 of the interior and exterior covers 180, 190 may define door engaging surfaces on the door channel walls 122b, 123b, which may provide a softer door engaging surface, for example, to provide a moisture barrier or seal between the door and the astragal, accommodate dimensional tolerances, and/or minimize marring of the door surfaces. As shown, the second hook portion 193 of the exterior cover 190 may be provided with flexible rib portions 193-1 to provide enhances sealing engagement with the passive door Dₚ. The interior and exterior covers 180, 190 may be provided in a variety of suitable materials, including, for example, acrylonitrile styrene acrylate (ASA), polyvinyl chloride (PVC) or other suitable plastic compounds.

In some embodiments, the outer lateral wall shoulder portion 126 may be provided with an inner lateral groove or recess 126b receiving a vertically extending elastomeric (e.g., foamed/jacketed, rubber) gasket or weatherstrip 128 for sealing engagement with the closed active door panel Da.

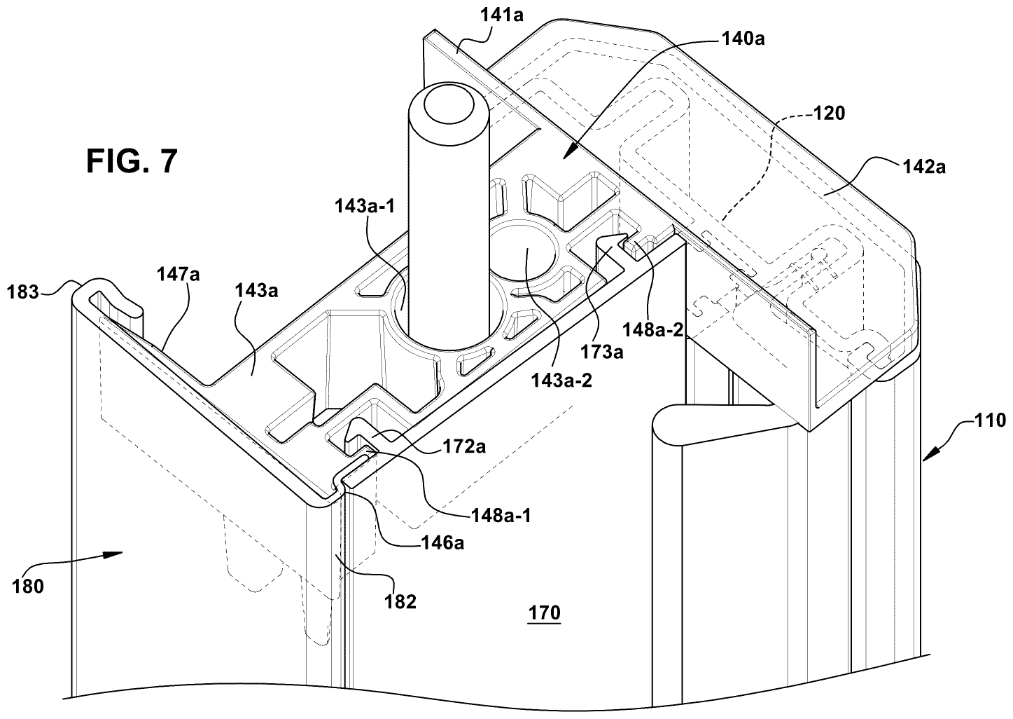

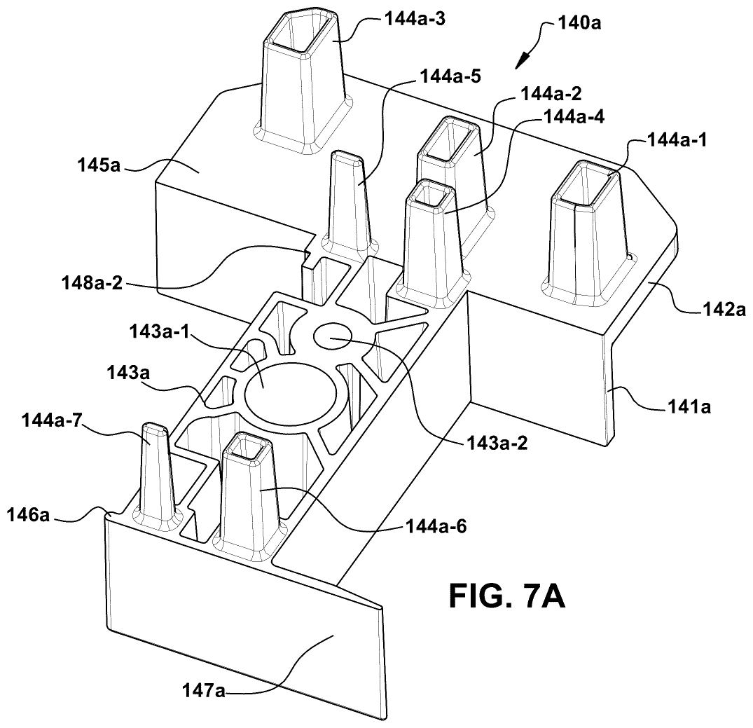

Referring to FIGS. 7 and 7A, in some embodiments, the astragal housing 110 may include an upper trim cap or boot 140a assembled with the upper end of the housing frame 120 to define the housing upper end 111 and to provide a stepped surface for mating with the upper door frame. The upper trim cap 140a may be provided in any suitable material, including, for example, hard plastic materials such as nylon or other suitable plastic compounds, or thermoplastic elastomeric (TPE) or thermoplastic vulcanisates (TPV) or other suitable elastomeric compounds, to provide a rigid surface for sealing against a door frame weather strip (not shown). In the illustrated embodiment, the upper trim cap 140a includes a vertical wall portion 141a and a horizontal wall portion 142a defining the stepped surface, and a latch channel covering block portion 143a that includes a bolt hole 143a-1 for receiving the upper shoot bolt 131a therethrough, and a mounting hole 143a-2 for receiving a mounting fastener 149a (see FIG. 4) for anchoring attachment to the housing frame 120 (e.g., to the outer bracket flange 138a). In some embodiments, the upper trim cap 140a includes one or more lower leg portions 144a-1 through 144a-7 extending from a lower surface 145a of the upper trim cap and received (e.g., press fit) in corresponding upper cavity portions 118-1 through 118-7 in the housing frame 120 (see FIG. 6A). As shown, the lower surface 145a of the upper trim cap 140a may be substantially flush with the upper ends of the housing frame 120 and the exterior cover 190. In the illustrated embodiment, the channel cover 170 and the interior cover 180 may extend to cover side portions of the trim cap 140a, thereby providing aesthetically uniform interior and doorway surface of the astragal 100 without requiring a notched cut of the astragal housing upper end, a difficult and potentially hazardous cutting operation often performed on conventional astragal housings to provide a similar flush-mounted trim cap arrangement.

To provide side covering engagement between the upper trim cap 140a and the interior cover 180, the upper trim cap 140a may include a latch-side distal edge 146a that aligns with the distal edge 122a-2 of the inner latch channel wall 122a for corresponding engagement with the uppermost end of the interior cover first hook portion 182, and a door-side inner lateral wall portion 147a that aligns with the inner door channel wall 122b for corresponding engagement with the uppermost end of the interior cover second hook portion 183. Likewise, to provide side covering engagement between the upper trim cap 140a and the channel cover 170, the block portion 143a of the upper trim cap 140a may include laterally inward extending flange portions 148a-1, 148a-2 that align with the laterally inward extending flange portions 122a-1, 123a-1 of the inner and outer latch channel walls 122a, 123a for corresponding snap-in engagement with the flexible tab portions 172a, 173a of the channel cover 170.

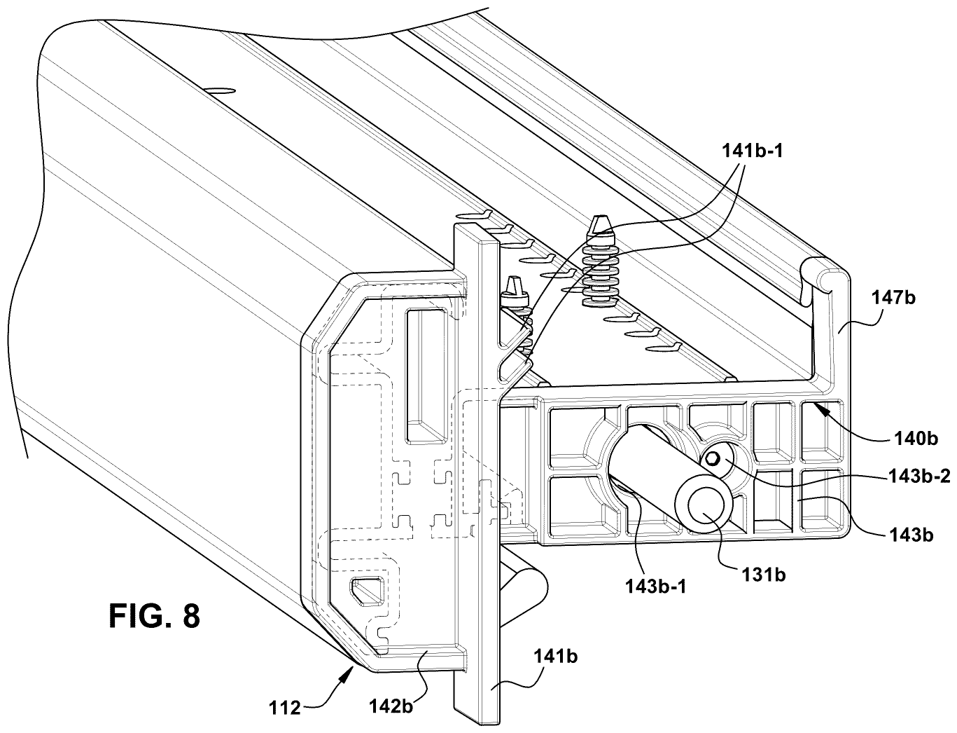

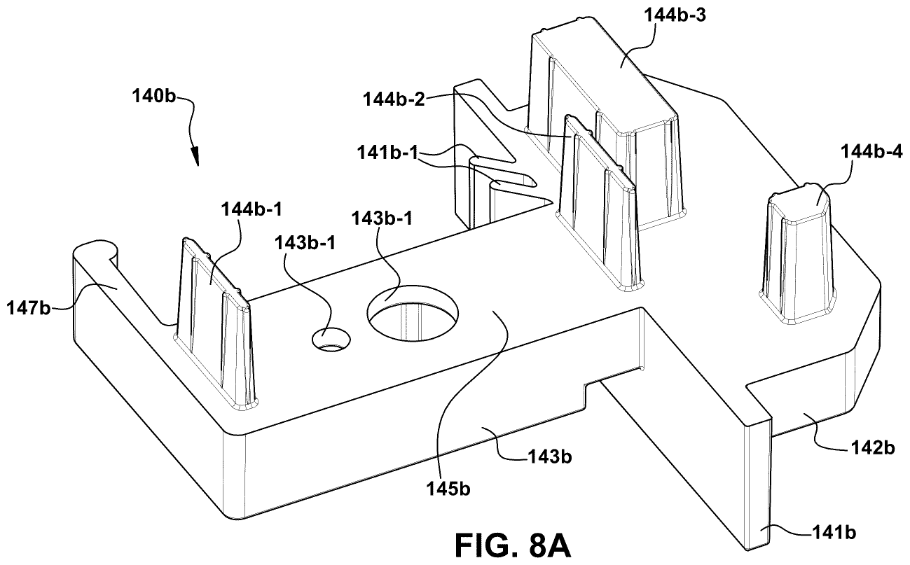

Referring to FIGS. 8 and 8A, in some embodiments, the astragal housing 110 may include a lower trim cap or boot 140b assembled with the lower end of the housing frame 120 to define the housing lower end 112 and to provide a stepped surface for mating with the upper door frame. The lower trim cap 140b may be provided in any suitable material, including, for example, soft elastomeric materials such as rubber or thermoplastic elastomeric (TPE) or thermoplastic vulcanisates (TPV) or other suitable elastomeric compounds, to provide a flexible door sweep for sealing against a lower door frame or door jamb. In the illustrated embodiment, the lower trim cap 140b includes a vertical wall portion 141b and a horizontal wall portion 142b defining the stepped door sweep portion, and a latch channel covering block portion 143b that includes a bolt hole 143b-1 for receiving the lower shoot bolt 131b therethrough, and a mounting hole 143b-2 for receiving a mounting fastener 149b (see FIG. 5) for anchoring attachment to the housing frame 120 (e.g., to the outer bracket flange 138b). In some embodiments, the lower trim cap 140b includes one or more upper leg portions 144b-1 through 144b-4 extending from an upper surface 145b of the upper trim cap and received (e.g., press fit) in corresponding lower cavity portions 119-1 through 119-4 in the housing frame 120 (see FIG. 6B). As shown, the upper surface 145b of the lower trim cap 140b may be substantially flush with the lower ends of the housing frame 120, the channel cover 170, the interior cover 180, and the exterior cover 190.

The lower trim cap 140b may include a door-side inner lateral wall portion 147b that aligns with the interior cover 180 to provide a smooth, uniform appearance. The inner lateral wall portion 147b is spaced apart from the vertical wall portion 141b to receive the passive door edge therebetween. The inner lateral surface of the vertical wall portion 141b may be provided with angled flexible fins 141b-1 providing flexible engagement with the passive door, for example, to provide sealing engagement and/or accommodate dimensional tolerances. The inner lateral surface of the inner lateral wall portion may be provided with similar flexible fins (not shown).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. An astragal housing comprising:
a housing frame comprising:
a vertically extending mounting wall defining a mounting surface configured for external attachment along a non-hinged vertical edge of a passive door panel;
inner and outer vertically extending latch channel walls extending from the mounting wall in a first direction to define a vertically extending latch channel opposite the mounting surface; and
inner and outer vertically extending door channel walls extending from the mounting wall in a second direction opposite the first direction to define a vertically extending door channel including the mounting surface; and
an interior cover having a first hook portion extending over a distal edge of the inner latch channel wall and a second hook portion extending over a distal edge of the inner door channel wall, the interior cover defining an inner lateral surface of the astragal housing.

2. The astragal housing of claim 1, further comprising a channel cover having inner and outer lateral end portions engaging the inner and outer vertically extending latch channel walls to cover at least a portion of the latch channel.

3. The astragal housing of claim 2, wherein the inner and outer lateral end portions of the channel cover include inner and outer tab portions that snap into retaining engagement with laterally inward extending flange portions of the inner and outer vertically extending latch channel walls.

4. The astragal housing of claim 2, wherein the first hook portion is captured between the inner lateral end portion of the channel cover and the flange portion of the inner latch channel wall.

5. The astragal housing of claim 1, wherein the distal edge of the inner door channel wall comprises a tapered wall surface and the second hook portion is laterally biased against the tapered wall surface to pull the first hook portion against the distal edge of the inner latch channel wall.

6. The astragal housing of claim 1, wherein the housing frame includes an inner lateral wall portion extending from an inner lateral end of the mounting wall and defining the inner latch channel wall and the inner door channel wall, and an outer lateral wall portion extending from an outer lateral end of the mounting wall and defining the outer latch channel wall and the outer door channel wall.

7. The astragal housing of claim 6, further comprising an exterior cover having a first hook portion extending over a first end of the outer lateral wall portion and a second hook portion extending over a second end of the outer lateral wall portion, the exterior cover defining an outer lateral surface of the astragal housing.

8. The astragal housing of claim 6, wherein the outer lateral wall portion further includes a shoulder portion laterally outward of and extending forward of the outer latch channel wall for engagement with a non-hinged vertical edge of an active door panel.

9. The astragal housing of claim 8, further comprising a vertically extending gasket installed in an inner lateral recess of the shoulder portion.

10. The astragal housing of claim 8, wherein the housing frame includes a first frame member defining the inner lateral wall portion and the outer latch channel wall, and a second frame member defining the outer door channel wall and the shoulder portion, the first and second frame members being joined by a thermal barrier element.

11. The astragal housing of claim 1, further comprising an upper trim cap assembled with an upper end of the housing frame.

12. The astragal housing of claim 11, wherein the upper trim cap including an inner wall having a first end that aligns with the inner latch channel wall and a second end that aligns with the inner door channel wall, wherein the first hook portion of the interior cover extends over the first end of the upper trim cap inner wall and the second hook portion of the interior cover extends over the second end of the upper trim cap inner wall.

13. The astragal housing of claim 11, wherein the upper trim cap includes laterally inward extending flange portions that align with laterally inward extending flange portions of the inner and outer vertically extending latch channel walls, the astragal housing further comprising a channel cover having inner and outer lateral end portions of the channel cover include inner and outer tab portions that snap into retaining engagement with the laterally inward extending flange portions of the upper trim cap and the inner and outer vertically extending latch channel walls.

14. The astragal housing of claim 11, wherein the upper trim cap includes a body portion having a lower surface that abuts an upper edge of the housing frame, and one or more leg portions extending from the body portion lower surface into sliding abutment with the housing frame.

15. An astragal housing comprising:
a housing frame comprising:
a vertically extending mounting wall defining a mounting surface configured for external attachment along a non-hinged vertical edge of a passive door panel;
an inner lateral wall portion extending from an inner lateral end of the mounting wall, the inner lateral wall portion defining an inner latch channel wall extending from the mounting wall in a first direction and an inner door channel wall extending from the mounting wall in a second direction opposite the first direction; and
an outer lateral wall portion extending from an outer lateral end of the mounting wall, the outer lateral wall portion defining an outer latch channel wall extending from the mounting wall in a first direction and an outer door channel wall extending from the mounting wall in a second direction opposite the first direction; and
an exterior cover having a first hook portion extending over a first end of the outer lateral wall portion and a second hook portion extending over a second end of the outer lateral wall portion, the exterior cover defining an outer lateral surface of the astragal housing.

16. The astragal housing of claim 15, wherein the outer lateral wall portion further includes a shoulder portion laterally outward of and extending forward of the outer latch channel wall for engagement with a non-hinged vertical edge of an active door panel.

17. The astragal housing of claim 16, further comprising a vertically extending gasket installed in an inner lateral recess of the shoulder portion.

18. The astragal housing of claim 16, wherein the housing frame includes a first frame member defining the inner lateral wall portion and the outer latch channel wall, and a second frame member defining the outer door channel wall and the shoulder portion, the first and second frame members being joined by a thermal barrier element.

19. The astragal housing of claim 15, further comprising a channel cover having inner and outer lateral end portions engaging the inner and outer vertically extending latch channel walls to cover at least a portion of the latch channel.

20. The astragal housing of claim 19, wherein the inner and outer lateral end portions of the channel cover include inner and outer tab portions that snap into retaining engagement with laterally inward extending flange portions of the inner and outer vertically extending latch channel walls.
